(19) United States
(12) Patent Application Publication
(10) Pub. No.: US 2012/0117627 A1
(43) Pub. Date: May 10, 2012

(54) Authority Control Systems and Methods

(75) Inventors: Kuan-Chieh Huang, Taipei Hsien (TW); Yuan-Peng Wang, Taipei Hsien (TW); Yi-Wen Liu, Taipei Hsien (TW)

(73) Assignee: ACER INCORPORATED, Taipei Hsien (TW)

(21) Appl. No.: 13/070,848

(22) Filed: Mar. 24, 2011

(30) Foreign Application Priority Data
Nov. 5, 2010 (TW) 99138087

(51) Int. Cl. G06F 21/20

(52) U.S. Cl. 726/4

(57) ABSTRACT

Authority control systems and methods are provided. The system at least includes a first electronic device and a second electronic device. The second electronic device is coupled to the first electronic device. The second electronic device receives an authority setting for the first electronic device, and transmits the authority setting to the first electronic device. The first electronic device determines an access control operation regarding the first electronic device towards the second electronic device according to the authority setting.

### CROSS REFERENCE TO RELATED APPLICATIONS

This application claims priority of Taiwan Patent Application No. 099138087, filed on Nov. 5, 2010, the entirety of which is incorporated by reference herein.

### BACKGROUND OF THE INVENTION

1. Field of the Invention

The disclosure relates generally to authority control systems and methods, and, more particularly to systems and methods that manage the access authority for respective electronic devices in a digital home.

2. Description of the Related Art

In a digital home network, electronic devices, such as computers, mobile phones, servers and players, which follow the DLNA (Digital Living Network Alliance) protocol can share multi-media content, such as movies, music and photos for playback via the network.

Generally, each electronic device in the digital home network can have control software. The control software can be used to open or close the share and playback functions for content in the electronic device. However, the operation of the control software requires related operational knowledge and many manual operations, and it is time-consuming and inconvenient for users.

Currently, some control software cannot support a function for opening or closing specific targets. For example, when the playback function of an electronic device is closed, all other electronic device cannot play back streaming media on the electronic device. Further, some control software cannot support the function for opening or closing specific targets. That is, users cannot use the control software to set whether specific electronic devices can browse the content in the electronic device. Similarly, the setting operation of the control software is minute and complicated. Further, since the access authority controls for the respective specific electronic devices are set and managed in the electronic device, the load of the electronic device and related resources consumed for handling the access authority control is increased.

### BRIEF SUMMARY OF THE INVENTION

Authority control systems and methods are provided.

An embodiment of an authority control system includes a first electronic device and a second electronic device. The second electronic device is coupled to the first electronic device. The second electronic device is arranged to receive an authority setting for the first electronic device, and transmit the authority setting to the first electronic device. The first electronic device is arranged to determine an access control operation regarding the first electronic device towards the second electronic device according to the authority setting.

In an embodiment of an authority control method, an authority setting for a first electronic device is received by a second electronic device. The authority setting is transmitted from the second electronic device to the first electronic device. After the authority setting is received by the first electronic device, an access control operation regarding the first electronic device towards the second electronic device is determined according to the authority setting by the first electronic device.

In some embodiments, when the authority setting indicates that the first electronic device is blocked, the first electronic device is arranged to delete the second electronic device or at least one service of the second electronic device from an interface according to the authority setting, or display a status of the second electronic device as an off-line status.

In some embodiments, the first electronic device and the second electronic device can respectively executes a central control program for performing the communications between the first electronic device and the second electronic device. The second electronic device is arranged to receive the authority setting via the central control program, and transmit the authority setting to the central control program in the first electronic device. The central control program in the first electronic device performs the access control operation regarding the first electronic device towards the second electronic device according to the authority setting.

In some embodiments, the second electronic device can be arranged to record the authority setting for the first electronic device. When the status of the first electronic device is switched from the off-line status to an on-line status, or a central control program in the first electronic device is activated, the first electronic device is arranged to transmit a notification message to the second electronic device. In response to the notification message, the second electronic device is arranged to transmit the authority setting to the first electronic device, such that the first electronic device determines the access control operation regarding the first electronic device towards the second electronic device according to the authority setting.

Authority control methods may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of an authority control system of the invention;

FIG. 2 is a flowchart of an embodiment of an authority control method of the invention;

FIG. 3 is a schematic diagram illustrating an embodiment of an example of an interface of a central control program in the second electronic device of the invention;

FIG. 4 is a schematic diagram illustrating an embodiment of an example of an interface of the central control program in the first electronic device before the authority control of the invention;

FIG. 5 is a schematic diagram illustrating an embodiment of an example of the interface of the central control program in the first electronic device after the authority control of the invention; and

FIG. 6 is a flowchart of another embodiment of an authority control method of the invention.

### DETAILED DESCRIPTION OF THE INVENTION

Authority control systems and methods are provided.

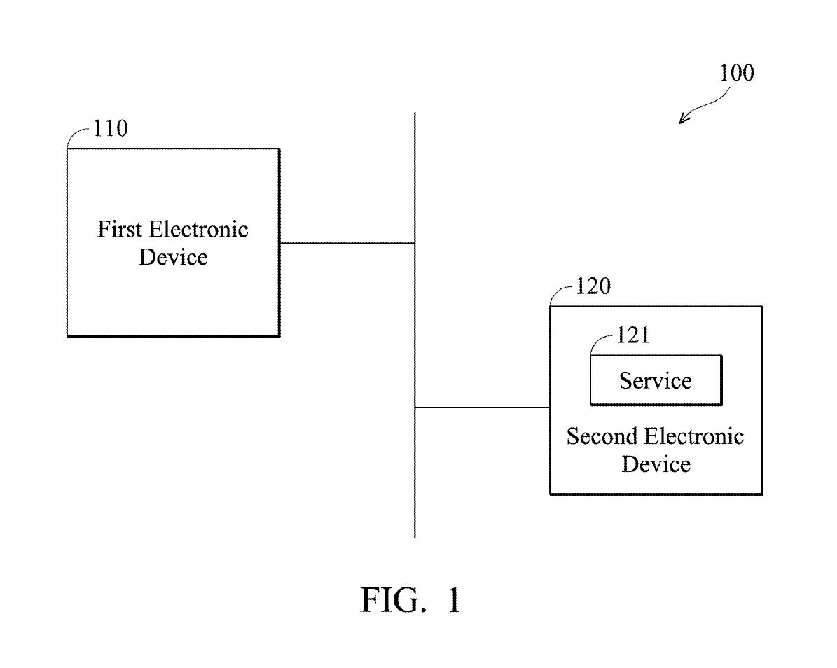

FIG. 1 is a schematic diagram illustrating an embodiment of an authority control system of the invention.

The authority control system 100 may comprise, but is not limited to, a first electronic device 110 and a second electronic device 120. The first electronic device 110 or the second electronic device 120 can be an electronic device, such as a computer, a mobile phone, a server, or a playback device. The first electronic device 110 and the second electronic device 120 can both support the DLNA protocol, and couple with each other. The second electronic device 120 has at least one service 121. The service 121 may be a resource, such as a video file, a music file, and/or an image file, or an application with a function of an image display, audio output, and/or video playback.

It is understood that each electronic device in the home network can be arranged to execute a central control program (not shown in FIG. 1) for performing the communications between the electronic devices. The central control program on the respective electronic device can be used to set the authority setting for the respective electronic device in the home network. The central control program on the respective electronic device can receive the authority settings from other electronic devices, and perform related access control operations for the electronic device installing the central control program according to the received authority settings. Detail of the access control operation will be discussed later.

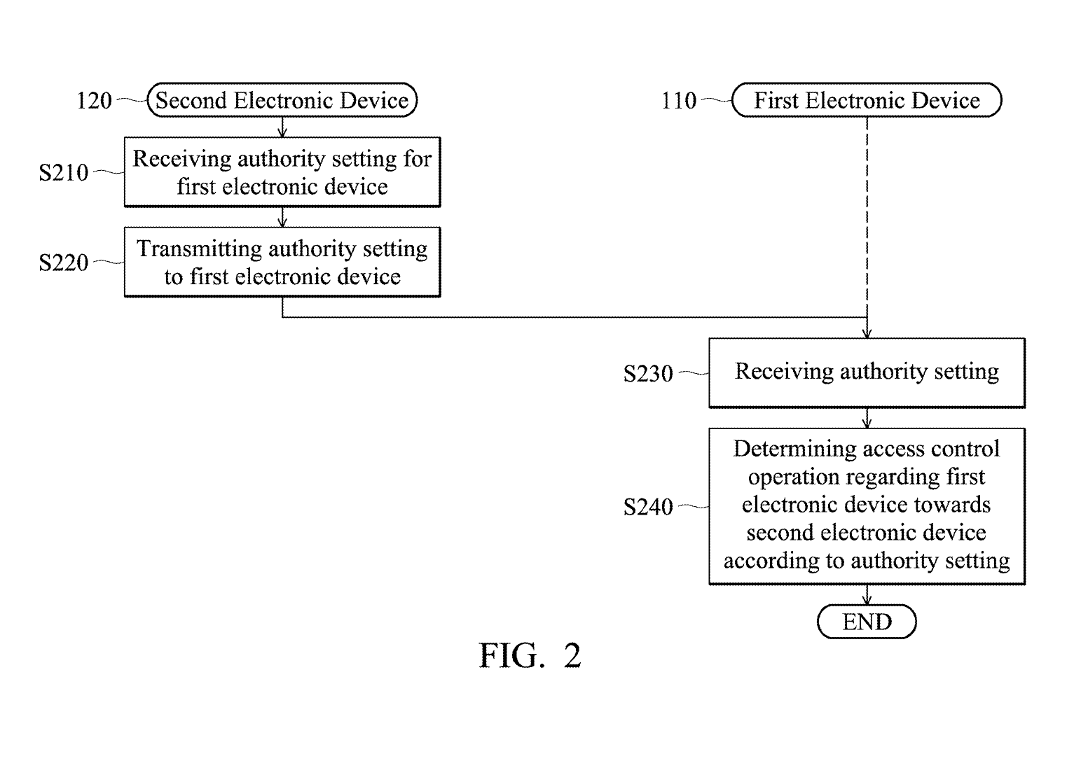

FIG. 2 is a flowchart of an embodiment of an authority control method of the invention. The authority control method can be used in a digital home having a plurality of electronic devices.

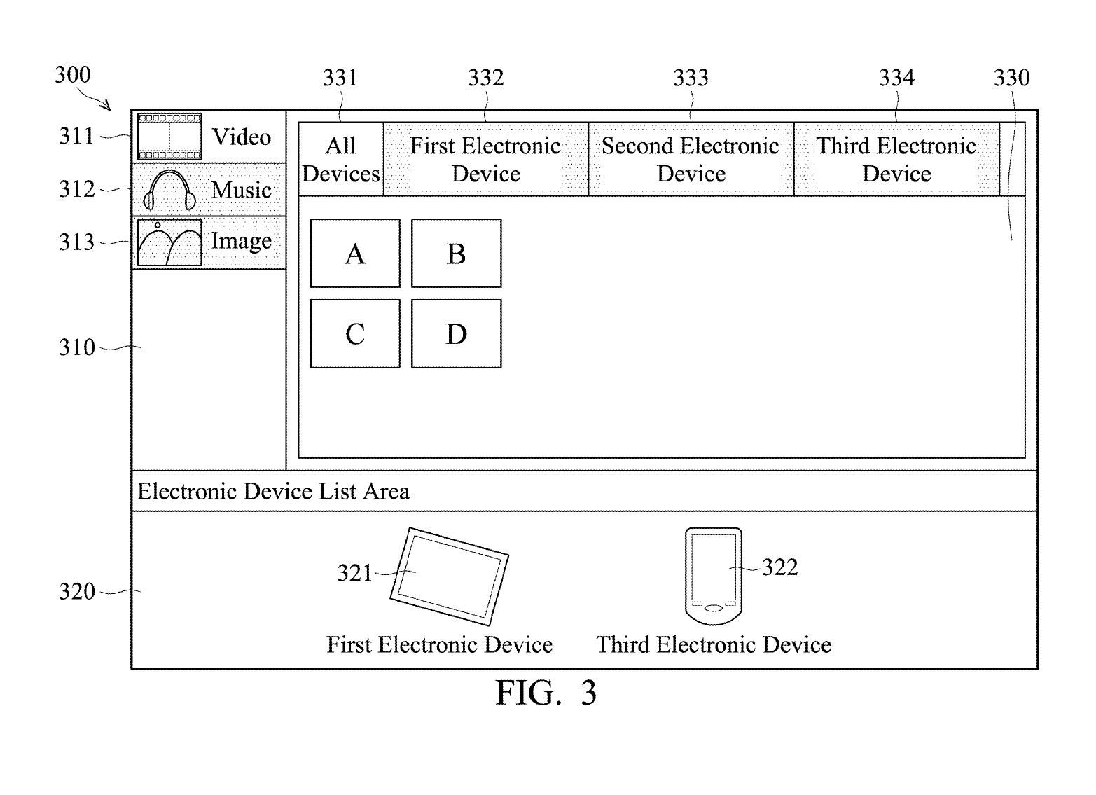

In step S210, the second electronic device 120 is arranged to receive an authority setting for the first electronic device 110. It is understood that, in some embodiments, the second electronic device 120 can be arranged to record the authority setting corresponding to the first electronic device 110. FIG. 3 is a schematic diagram illustrating an embodiment of an example of an interface of a central control program in the second electronic device of the invention. As shown in FIG. 3, the interface 300 of the central control program may have a service type area 310, an electronic device list area 320, and a content presentation area 330. The service type area 310 can display various types of services, such as a video type 311, a music type 312, and an image type 313. The electronic device list area 320 can display schematic diagrams corresponding to other electronic devices except the electronic device installing the central control program (the second electronic device 120) in the home network. For example, the electronic device list area 320 can display a schematic diagram 321 corresponding to the first electronic device 110, and a schematic diagram 322 corresponding to a third electronic device. The content presentation area 330 can display services of each electronic device in respective service types, wherein the services can be shared/accessed by other electronic devices. It is noted that, when one of the schematic diagrams (331, 332, 333, and 334) corresponding to electronic devices displayed in the content presentation area 330 is selected, the services which can be shared in the selected electronic device will be displayed in the content presentation area 330. In the example of FIG. 3, the videos which can be shared by all electronic device are videos A˜D. As described, the central control program on the respective electronic device can be used to set the authority setting for the respective electronic device in the home network. When a user wants to perform related authority settings for the first electronic device 110 in the second electronic device 120, the user can select the schematic diagram 321 corresponding to the first electronic device 110 in the electronic device list area 320 (or click the right button of a mouse on the schematic diagram 321). When the schematic diagram 321 is selected, the central control program can display a menu comprising at least a block selection and a unblock selection. The user can select one of the selections, thus completing the authority setting for the first electronic device 110. It is understood that, in some embodiments, the user can also perform related authority settings regarding the respective services in the second electronic device 120 for the first electronic device 110. It is noted that, the above manner for authority setting is an example of the present application, and the present invention is not limited thereto.

In step S220, the second electronic device 120 is arranged to transmit the authority setting to the first electronic device 110. It is understood that, in some embodiments, the second electronic device 120 can be arranged to package the authority setting into a UDP (User Datagram Protocol) packet, and transmit the UDP packet to the first electronic device 110. It is noted that, in some embodiments, the UDP packet can comprise a MAC (Media Access Control) code corresponding to the first electronic device 110 and the authority setting. As described, in some embodiments, the user can perform related authority settings regarding the respective services in the second electronic device 120 for the first electronic device 110. In an embodiment of the authority setting regarding the respective services, the UDP packet can comprise the MAC code corresponding to the first electronic device 110, the authority setting, and the identification code corresponding to a specific service in the second electronic device 120. It is understood that, in some embodiments, the second electronic device 120 can be arranged to broadcast the UDP packet. When other electronic devices except the first electronic device 110 receive the UDP packet, each electronic device will parse the UDP packet to obtain the MAC code corresponding to the first electronic device 110, thus ignoring the packet.

After the first electronic device 110 receives the authority setting from the second electronic device 120 in step S230, in step S240, the first electronic device 110 is arranged to determine an access control operation regarding the first electronic device 110 towards the second electronic device 120 according to the received authority setting. It is noted that, as described, the central control program can perform the communications between the electronic devices. In some embodiments, the second electronic device 120 can be arranged to transmit the authority setting to the central control program in the first electronic device 110 via the central control program in the second electronic device 120, and the central control program in the first electronic device 110 can perform the access control operation regarding the first electronic device 110 towards the second electronic device 120 according to the received authority setting.

It is noted that, in some embodiments, when the authority setting indicates that the first electronic device 110 is blocked, the first electronic device 110 or the central control program in the first electronic device 110 can be arranged to delete the schematic diagram corresponding to the second electronic device 120 from the interface of the central control program according to the authority setting, or display a status of the second electronic device 120 as an off-line status. Additionally, in some embodiments, when the authority setting indicates that the first electronic device 110 is blocked, the first electronic device 110 or the central control program in the first electronic device 110 can be arranged to delete the schematic diagram corresponding to the service in the second electronic device 120 from the interface of the central control program according to the authority setting. It is understood that, since the first electronic device 110 cannot see the second electronic device 120 and/or the services in the second electronic device 120 from the interface, the first electronic device 110 cannot access the second electronic device 120 and its services. When the user of the first electronic device 110 wants to drag the service, such as a specific video to the second electronic device 120, the central control program can directly block the operation.

It is understood that, when the authority setting indicates that the first electronic device 110 is unblocked, the procedure of unblocking is similar to that of blocking. When the first electronic device 110 receives the authority setting indicating that the first electronic device 110 is unblocked, the first electronic device 110 or the central control program in the first electronic device 110 can be arranged to display the schematic diagram corresponding to the second electronic device 120 in the interface, display the schematic diagram corresponding to the service in the second electronic device 120 in the interface, or display a status of the second electronic device 120 as an on-line status.

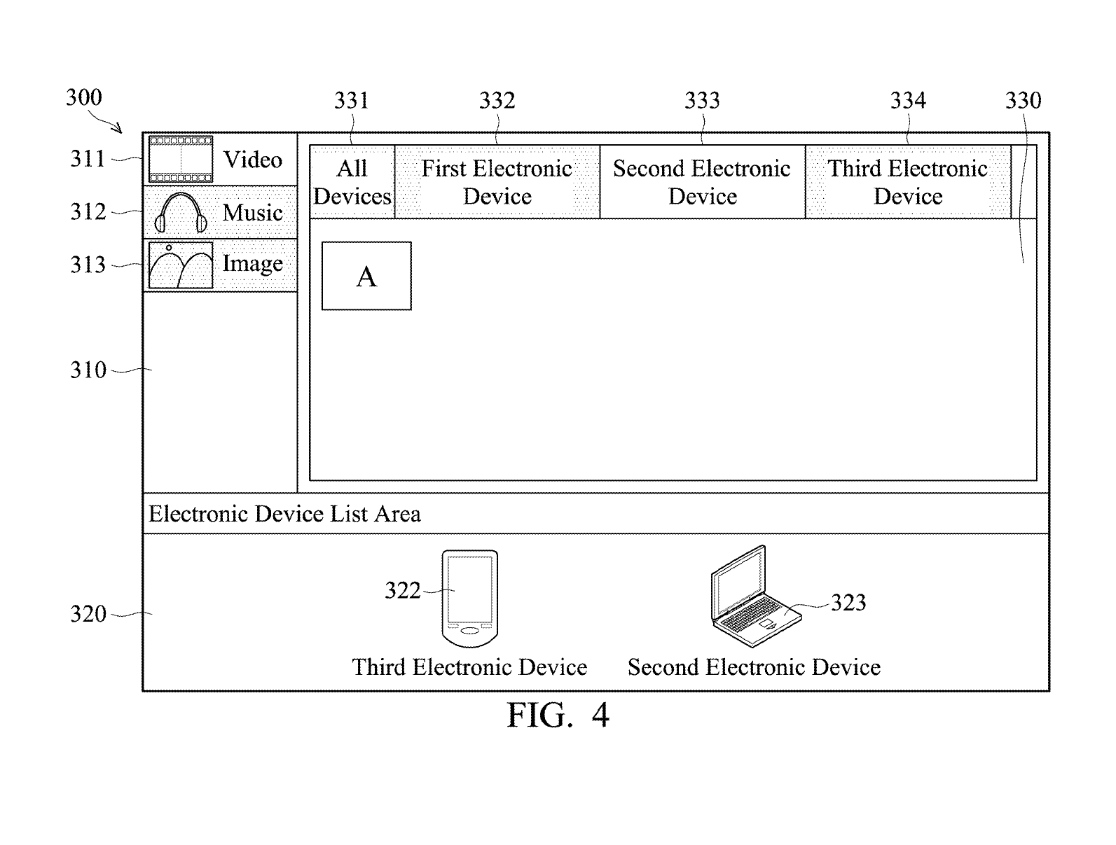

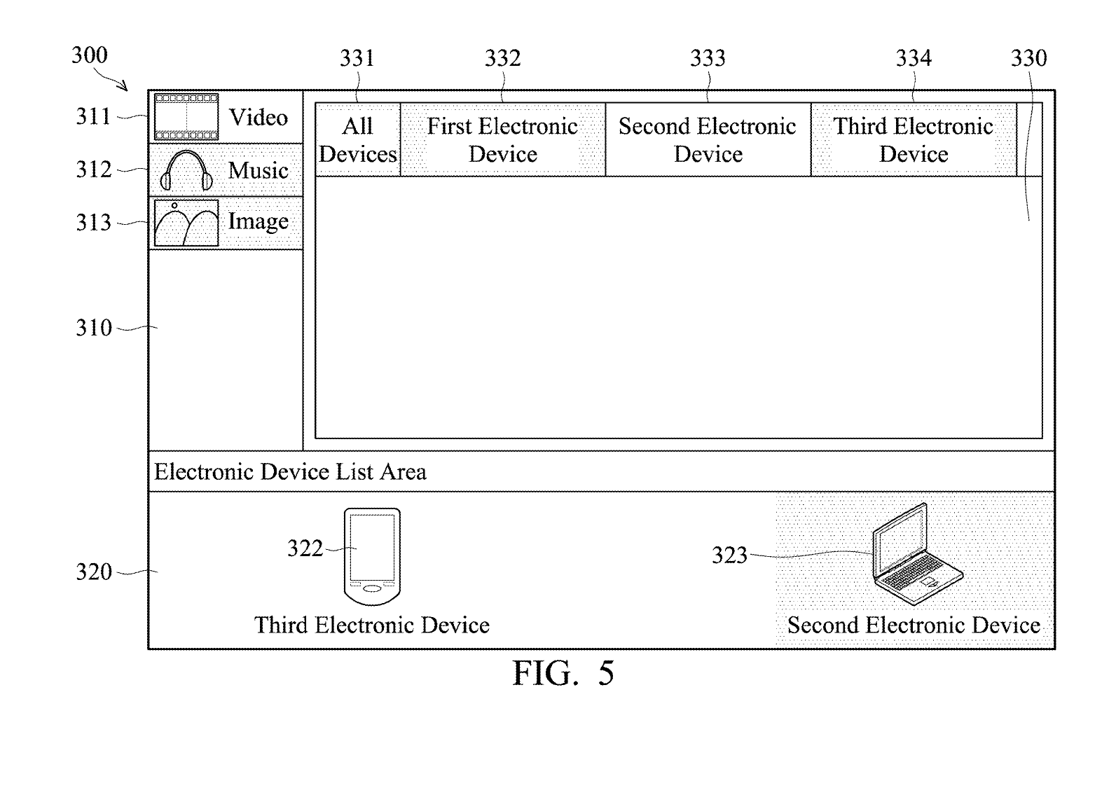

FIG. 4 is a schematic diagram illustrating an embodiment of an example of an interface of the central control program in the first electronic device before the authority control of the invention. As show in FIG. 4, the interface 300 of the central control program in the first electronic device 110 can display the services which can be shared in the respective electronic devices, in which the service in the second electronic device 120 includes video A. When the user of the second electronic device 120 blocks the first electronic device 110 (the first electronic device 110 is blocked from accessing the second electronic device 120 and its service), and the interface 300 of the central control program in the first electronic device 110 after the authority control, as shown in FIG. 5. In the interface 300 of the central control program in the first electronic device 110 after the authority control, the status of the second electronic device 120 is displayed as an off-line status, and no service can be shared in the second electronic device 120. It is understood that, when the schematic diagram 333 corresponding to the second electronic device 120 is selected, no service is displayed in the content presentation area 330.

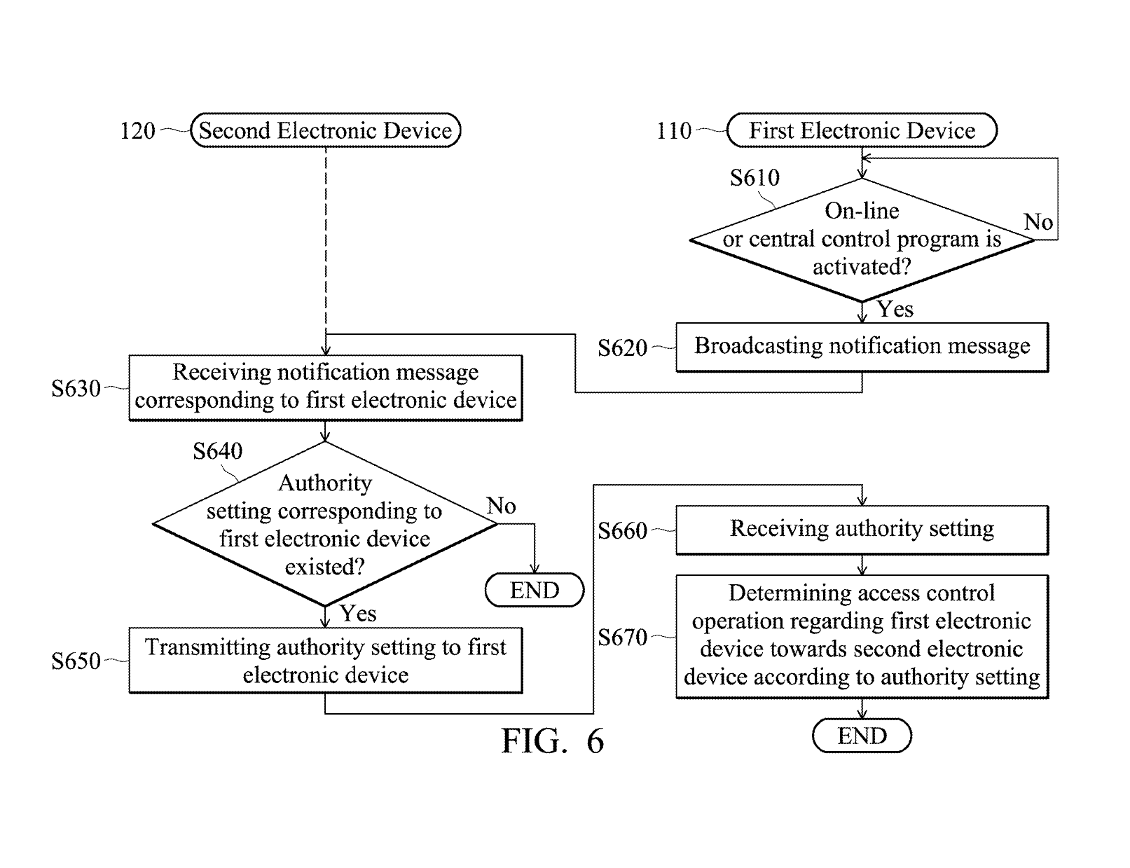

FIG. 6 is a flowchart of another embodiment of an authority control method of the invention. In this embodiment, the authority control operation for electronic devices with an off-line status or without executing the central control program is disclosed.

In step S610, it is determined whether the status of the first electronic device 110 is switched from the off-line status to the on-line status, or whether the central control program is activated in the first electronic device 110. If the status of the first electronic device 110 is not switched from the off-line status to the on-line status, or the central control program is not activated in the first electronic device 110 (No in step S610), the procedure remains at step S610. If the status of the first electronic device 110 is switched from the off-line status to the on-line status, or the central control program is activated in the first electronic device 110 (Yes in step S610), in step S620, the first electronic device 110 or the central control program in the first electronic device 110 is arranged to broadcast a notification message to all electronic devices in the home network.

It is noted that, each electronic device must perform the operations of step S630 to S650. For simplified purposes, only the operation of the second electronic device 120 is discussed in this embodiment. When the second electronic device 120 receives the notification message from the first electronic device 110 in step S630, in step S640, it is determined whether an authority setting for the first electronic device 110 is stored in a storage unit (not shown). If no authority setting for the first electronic device 110 is stored in the storage unit (No in step S640), the procedure is terminated. If an authority setting for the first electronic device 110 is stored in the storage unit (Yes in step S640), in step S650, the second electronic device 120 or the central control program in the second electronic device 120 is arranged to transmit the authority setting to the first electronic device 110. After the first electronic device 110 receives the authority setting from the second electronic device 120 in step S650, in step S660, the first electronic device 110 is arranged to determine the access control operation regarding the first electronic device 110 towards the second electronic device 120 according to the received authority setting.

Therefore, the authority control systems and methods can use an easy and convenient manner to manage the access authority for respective electronic devices in a digital home, thus reducing the load of a single electronic device, and related resources consumed for handing the access authority control.

Authority control methods, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed:

1. An authority control system, comprising:
a first electronic device; and
a second electronic device coupled to the first electronic device, arranged for receiving an authority setting for the first electronic device, and for transmitting the authority setting to the first electronic device;
wherein the first electronic device is further arranged for determining an access control operation regarding the first electronic device towards the second electronic device according to the authority setting.

2. The system of claim 1, wherein when the authority setting indicates that the first electronic device is blocked, the first electronic device is further arranged for deleting the second electronic device or at least one service of the second electronic device from an interface according to the authority setting, or displaying a status of the second electronic device as an off-line status.

3. The system of claim 1, wherein the first electronic device and the second electronic device are further arranged for respectively executing a central control program in order to perform the communications between the first electronic device and the second electronic device, the second electronic device is further arranged for receiving the authority setting via the central control program, and transmitting the authority setting to the central control program in the first electronic device, and the central control program in the first electronic device is arranged for performing the access control operation regarding the first electronic device towards the second electronic device according to the authority setting.

4. The system of claim 1, wherein the second electronic device is further arranged for recording the authority setting for the first electronic device, and when the status of the first electronic device is switched from an off-line status to an on-line status, or a central control program in the first electronic device is activated, the first electronic device is further arranged for transmitting a notification message to the second electronic device, and in response to the notification message, the second electronic device is further arranged for transmitting the authority setting to the first electronic device, such that the first electronic device determines the access control operation regarding the first electronic device towards the second electronic device according to the authority setting.

5. The system of claim 1, wherein the second electronic device is further arranged for packaging the authority setting into a UDP packet, and for transmitting the UDP packet to the first electronic device.

6. The system of claim 5, wherein the UDP packet comprises a MAC code corresponding to the first electronic device and the authority setting.

7. The system of claim 1, wherein the first electronic device and the second electronic device respectively support the DLNA protocol.

8. An authority control method, comprising:
receiving an authority setting for a first electronic device by a second electronic device;
transmitting the authority setting to the first electronic device by the second electronic device; and
determining an access control operation regarding the first electronic device towards the second electronic device according to the authority setting by the first electronic device.

9. The method of claim 8, wherein when the authority setting indicates that the first electronic device is blocked, the method further comprises deleting the second electronic device or at least one service of the second electronic device from an interface according to the authority setting, or displaying a status of the second electronic device as an off-line status by the first electronic device.

10. The method of claim 8, further comprising respectively executing a central control program by the first electronic device and the second electronic device further for performing the communications between the first electronic device and the second electronic device, wherein the second electronic device receives the authority setting via the central control program, and transmits the authority setting to the central control program in the first electronic device, and the central control program in the first electronic device performs the access control operation regarding the first electronic device towards the second electronic device according to the authority setting.

11. The method of claim 8, further comprising:
recording the authority setting for the first electronic device by the second electronic device;
when the status of the first electronic device is switched from an off-line status to an on-line status, or a central control program in the first electronic device is activated, transmitting a notification message to the second electronic device by the first electronic device; and
in response to the notification message, transmitting the authority setting to the first electronic device by the second electronic device, such that the first electronic device determines the access control operation regarding the first electronic device towards the second electronic device according to the authority setting.

12. The method of claim 8, further comprising packaging the authority setting into a UDP packet, and transmitting the UDP packet to the first electronic device by the second electronic device.

13. The method of claim 12, wherein the UDP packet comprises a MAC code corresponding to the first electronic device and the authority setting.

14. The method of claim 8, wherein the first electronic device and the second electronic device respectively support the DLNA protocol.

15. A machine-readable storage medium comprising a computer program, which, when executed, causes a device to perform an authority control method, wherein the method comprises:
receiving an authority setting for a first electronic device; and
transmitting the authority setting to the first electronic device,
wherein the first electronic device determines an access control operation regarding the first electronic device towards the device according to the authority setting by the first electronic device.

16. A machine-readable storage medium comprising a computer program, which, when executed, causes a device to perform an authority control method, wherein the method comprises:
receiving an authority setting for a first electronic device; and
transmitting the authority setting to the first electronic device,
wherein the first electronic device determines whether to delete the device or at least one service of the device from an interface, or display a status of the device as an off-line status according to the authority setting.
